(19) United States
(12) Patent Application Publication
(10) Pub. No.: US 2024/0400746 A1
(43) Pub. Date: Dec. 5, 2024

(54) POLYURETHANE AND PREPARATION METHOD THEREOF

(71) Applicant: Industrial Technology Research Institute, Hsinchu (TW)

(72) Inventors: Ying-Chen Liao, Hsinchu County (TW); De-Lun Kuo, Hsinchu City (TW); Hsu-Tzu Fan, Hualien County (TW); Wei-Cheng Tang, Hsinchu City (TW); Cheng-Jyun Huang, Taoyuan City (TW); Shin-Liang Kuo, Hsinchu City (TW)

(73) Assignee: Industrial Technology Research Institute, Hsinchu (TW)

(21) Appl. No.: 18/393,589

(22) Filed: Dec. 21, 2023

(30) Foreign Application Priority Data
May 30, 2023 (TW) 112120057

(51) Int. Cl. C08G 18/48; C08G 63/181; C08G 63/82; C08J 11/24

(52) U.S. Cl. CPC C08G 18/4887; C08G 63/181; C08G 63/82; C08J 11/24; C08J 2367/03

(57) ABSTRACT

A polyurethane and a preparation method thereof are provided. The polyurethane is represented by Formula 1. The preparation method of the polyurethane includes performing an addition reaction between a polyester-polyether polyol represented by the Formula 4 and a di-isocyanate. The formed polyurethane has high elasticity and high moisture-permeable properties.

### CROSS-REFERENCE TO RELATED APPLICATION

This application claims the priority benefit of Taiwan application serial no. 112120057, filed on May 30, 2023. The entirety of the above-mentioned patent application is hereby incorporated by reference herein and made a part of this specification.

### TECHNICAL FIELD

The disclosure relates to a polyurethane and a preparation method thereof, and particularly to a polyurethane with high elasticity and high moisture-permeable properties and a preparation method thereof.

### BACKGROUND

In recent years, with the improvement of global health awareness, people's participation in sports and fitness has increased, which has led to an increase in the demand for fabrics with sports functions such as moisture absorption and perspiration, breathability and dryness, and elastic property. However, existing ingredients and methods for fabricating moisture-wicking textiles suffer from poor performance and high production costs.

### SUMMARY

According to embodiments of the disclosure, a polyurethane includes a chemical structure represented by Formula 1,

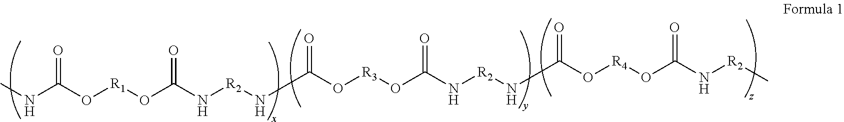

wherein,

R₁ is represented by Formula 2,

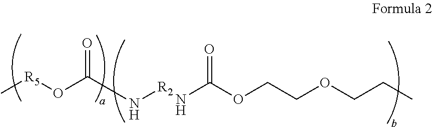

R₂ is independently a substituted or unsubstituted aryl group or alkyl group with a carbon number of 2 to 15;

R₃ is a substituted or unsubstituted alkyl group with a carbon number of 2 to 10;

R₄ is independently a substituted or unsubstituted alkyl group, oxyalkyl group or polydiacid glycol group with a carbon number of 20 to 300; and

R₅ is represented by Formula 3,

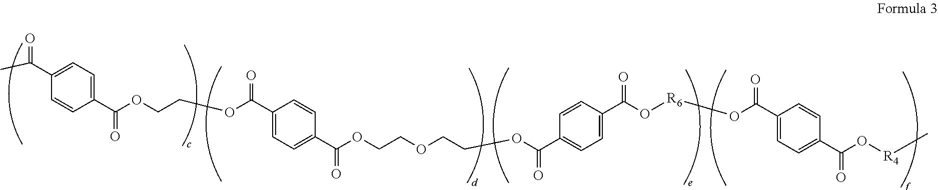

R₄ is the same as the aforementioned R₄;

R₆ is a substituted or unsubstituted branched alkyl group or ether group with a carbon number of 2 to 60, and

a and x are each independently an integer from 1 to 100, b, c, d, e and f are each independently an integer from 0 to 100, y is an integer from 0 to 50, and z is an integer from 0 to 50.

According to embodiments of the disclosure, a preparation method of a polyurethane includes:

subjecting a polyester-polyether polyol and a diisocyanate to an addition reaction, obtaining a polyurethane, wherein the polyester-polyether polyol has a structure represented by Formula 4,

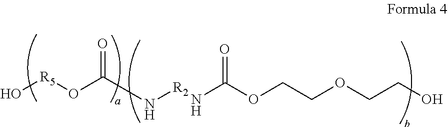

wherein R₂ is a substituted or unsubstituted aryl group or alkyl group with a carbon number of 2 to 15; and

R₅ is represented by Formula 3,

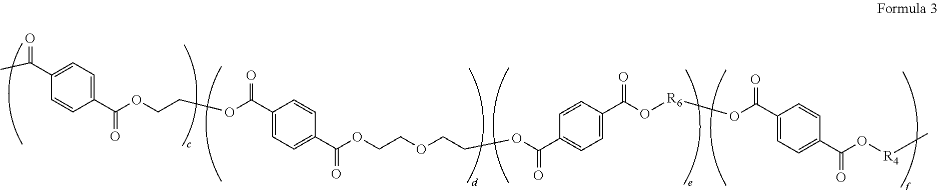

wherein R₄ is a substituted or unsubstituted alkyl group, oxyalkyl group or polydiacid glycol group with a carbon number of 20 to 300; and

R₆ is a substituted or unsubstituted branched alkyl group or ether group with a carbon number of 2 to 60, wherein a is an integer from 1 to 100, and b, c, d, e and f are each independently an integer from 0 to 100.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is spectrum information of an NMR analysis results of a polyurethane resin of embodiment 1 of the disclosure.

FIG. 2 is spectrum information of an NMR analysis results of a polyurethane resin of embodiment 2 of the disclosure.

FIG. 3 is spectrum information of an NMR analysis results of a polyurethane resin of embodiment 3 of the disclosure.

FIG. 4 is spectrum information of an NMR analysis results of a polyurethane resin of embodiment 4 of the disclosure.

FIG. 5 is spectrum information of an NMR analysis results of a polyurethane resin of embodiment 5 of the disclosure.

### DESCRIPTION OF THE EMBODIMENTS

The followings are embodiments used to describe the disclosure in detail. The implementation details provided in the embodiments are for illustration purposes, and are not intended to limit the scope of protection of the disclosure. Anyone with ordinary knowledge in the technical field can modify or change these implementation details according to actual implementation requirements.

In this article, terms such as “comprising”, “including”, and “having” are all open terms, which means “including but not limited to”.

Also, herein, a range expressed by “one value to another value” is a general representation to avoid enumerating all values in the range in the specification. Thus, the recitation of a particular numerical range encompasses any numerical value within that numerical range, as well as smaller numerical ranges bounded by any numerical value within that numerical range.

In the embodiments of the disclosure, a polyurethane is synthesized by designing a polyol of a polyether-polyester block structure and introducing a diisocyanate thereinto, and thus film products formed of the polyurethane may have excellent elasticity and moisture-permeable properties. Specifically, in the embodiments of the disclosure, a polyether chain segment is introduced after chemical depolymerizing the polyester, and thus the obtained polyether-polyester polyol solves the problem of crystalline domains produced by aromatic polyester polyols due to the easy stacking of benzene ring structures. Accordingly, the distribution of the moisture-permissive path of the formed polyurethane is more uniform, and a polyurethane with high elasticity and moisture-permeable properties is obtained. The polyester chain segment in the polyether-polyester block polyol can come from a recycling waste stream or a primary product stream. The polyester waste from the recycling waste stream (such as waste polyester products or waste polyester/polyurethane products) undergoes a chemical depolymerization process and a subsequent polymerization reaction with a polyether to produce a polyether-polyester block polyol. The aforementioned processes can be collectively referred to as a chemical depolymerization-polymerization reaction procedure. The polyester from the primary product stream is directly combined with the polyether through a chemical polymerization process to produce a polyether-polyester block polyol. The embodiment of the disclosure adopts the polyol design of the block structure, which combines the rigid aromatic ring polyester chain segment and the hydrophilic and soft polyether segment, so that the synthesized polyurethane has good toughness and elasticity and moisture-permeable properties. For example, the formed polyurethane has an elongation rate of more than 500% and is waterproof and breathable, so it can be used to produce elastic blended fabrics, and then expanded to more diverse applications of functional sports apparel.

In embodiments of the disclosure, a polyurethane includes a chemical structure represented by Formula 1,

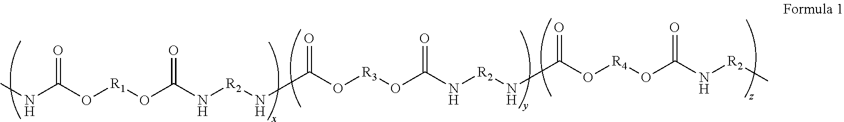

wherein R₁ is represented by the following Formula 2,

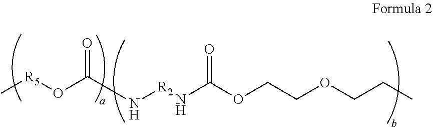

R₂ is independently a substituted or unsubstituted aryl group or alkyl group with a carbon number of 2 to 15;

R₃ is a substituted or unsubstituted alkyl group with a carbon number of 2 to 10;

R₄ is independently a substituted or unsubstituted alkyl group, oxyalkyl group or polydiacid glycol group with a carbon number of 20 to 300; and

R₅ is represented by Formula 3,

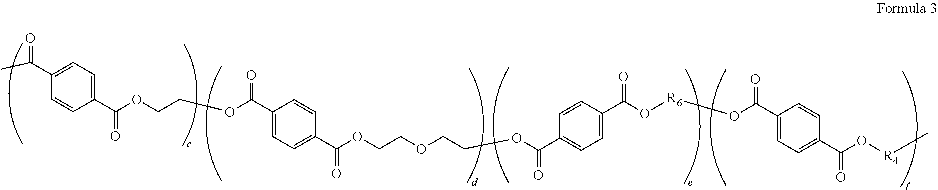

wherein R₄ is the same as the aforementioned R₄;

R₆ is a substituted or unsubstituted branched alkyl group or ether group with a carbon number of 2 to 60, and

a and x are an integer from 1 to 100, b, c, d, e and f are an integer from 0 to 100, y is an integer from 0 to 50, and z is an integer from 0 to 50.

In one embodiment of the disclosure, a and x are respectively an integer from 1 to 20, and y, z, b, c, d, e and f are respectively an integer from 0 to 20.

In one embodiment of the disclosure, R₂ is diphenylmethyl group (such as 4,4-diphenylmethyl group), tolyl group, dicyclohexyl methyl group, hexamethylene group, cyclohexyl group or 1,1,3-trimethylcyclohexyl group.

In embodiments of the disclosure, R₃ is ethyl group, n-propyl group, n-butyl group, n-

pentyl group, neopentyl group, hexyl group, dimethylpropyl group or ethoxy ethylpropyl group.

In embodiments of the disclosure, R₄ is ethoxy (EO) group, isopropoxy (PO) group, butoxy (BO) group, polyethoxypropoxy group, polyethoxybutoxyphenol group, phenolic methyl group, caprolactone group, ethylene adipate group, butylene adipate group or hexamethylene adipate group.

In embodiments of the disclosure, R₆ is 2-methyl-2,4-pentyl group, 2-butyl-2-ethyl propyl group, diethyl ether group or dimethyl propylene group.

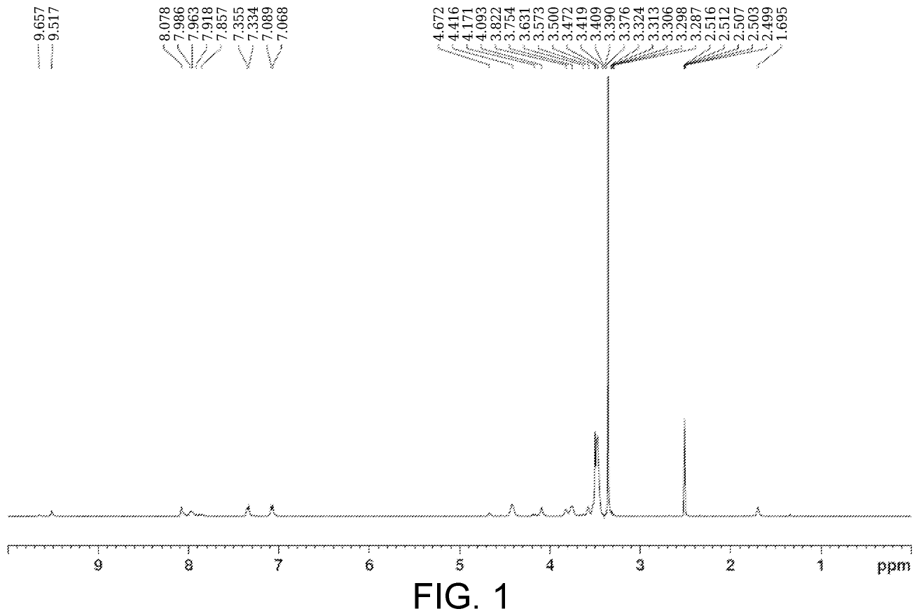

It is confirmed by a nuclear magnetic resonance (NMR) measurement that a polyurethane has the structure represented by the above Formula 1, and a chemical shift thereof in the NMR spectrum has a peak at about 3.50˜3.90 ppm, 4.40˜4.70 ppm, and 7.80˜8.10 ppm. The specific NMR spectra are shown in FIG. 1 to FIG. 5.

In embodiments of the disclosure, according to the JIS L1099A1 test method, the moisture permeability of the polyurethane is equal to or greater than 4000 g/m²·24 hours, and the elongation rate is greater than 500%.

In embodiments of the disclosure, the preparation method of the polyurethane includes subjecting a polyester-polyether polyol represented by the following Formula 4 and a diisocyanate to an addition reaction, to obtain a polyurethane,

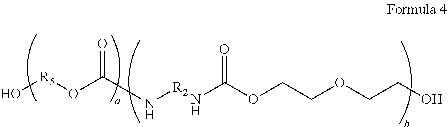

wherein R₂ is a substituted or unsubstituted aryl group or alkyl group with a carbon number of 2 to 15; and

R₅ is represented by Formula 3,

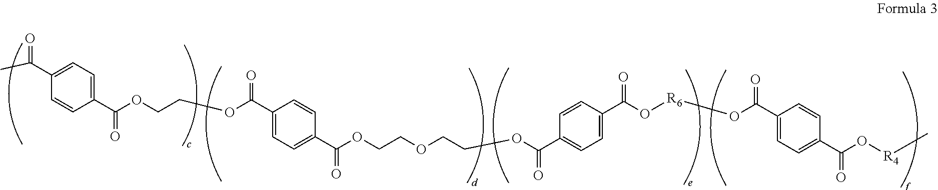

wherein R₄ is a substituted or unsubstituted alkyl group, oxyalkyl group or polydiacid glycol group with a carbon number of 20 to 300; and

R₆ is a substituted or unsubstituted branched alkyl group or ether group with a carbon number of 2 to 60, wherein a is an integer from 1 to 100, and b, c, d, e and f are an integer from 0 to 100.

In embodiments of the disclosure, the preparation method of the polyurethane includes the following steps. First, a chemical depolymerization of the polyester waste is carried out by adding a depolymerizing agent to the polyester waste. Next, the depolymerized polyester waste is polymerized with polyether polyol to form a polyester-polyether polyol. Then, an addition reaction is performed between the polyester-polyether polyol and a diisocyanate, to form a polyurethane. In embodiments of the disclosure, in the block structure of the formed polyester-polyether polyol, based on a total weight of the polyester-polyether polyol, the content of the polyester segment is 25 wt % to 40 wt %, and the content of the polyether segment is 50 wt % to 70 wt %. In embodiments of the disclosure, the polyurethane is obtained by performing a polymerization reaction of a polyester-polyether polyol, a polyether polyol, a catalyst, a diisocyanate, and a chain extender; and the polyester-polyether polyol is obtained from polyester material, depolymerizing agent, polyether diol, and catalyst through a chemical depolymerization-polymerization procedure. In embodiments of the disclosure, in the obtained polyurethane, a usage amount of a polyester is 10 wt % to 25 wt %, a usage amount of a polyether is between 30 wt % to 55 wt %, a usage amount of the diisocyanate is 10 wt % to 25 wt %, and a usage amount of a chain extender is 2 wt % to 8 wt %.

In embodiments, the preparation method of the polyurethane may include the following steps. First, a chemical depolymerization reaction is carried out at a temperature of 220° C. to 240° C. for 1 hour to 2 hours with a polyester waste, a depolymerizing agent, a polyether diol and a catalyst. In embodiments, the depolymerization temperature may be about 230° C. Then, the temperature is reduced to 180° C. to 220° C., and the pressure is gradually reduced, so that the molecular weight of the depolymerization product increases. Next, the temperature is reduced to 100° C. to 140° C. and the pressure is returned to normal pressure, so as to obtain a polyester-polyether polyol. Then, a diisocyanate is added to the polyester-polyether polyol to react at a temperature of 70° C. to 90° C. for 4 hours to 6 hours, and a diisocyanate is repeatedly added until the viscosity value of the obtained polymer reaches the set range, to obtain the polyurethane of embodiments of the disclosure.

In addition, the preparation method of the polyurethane of the disclosure may further include adding a solvent and an additive according to requirements. Hereinafter, the above-mentioned various components will be described in detail.

The polyester waste is not particularly limited. Examples of the polyester waste can include polyethylene terephthalate (PET) pellets, polybutylene terephthalate (PBT) pellets, recycled polyester bottle flakes, recycled polyester films, recycled polyester fibers, recycled PET fabrics, recycled PET/PU composite fabrics or other suitable polyester waste. The polyester waste can be used alone or in combination.

The depolymerizing agent is not particularly limited, and an appropriate depolymerizing agent can be selected according to requirements. For example, a branched diol such as diethylene glycol (DEG), 2-butyl-2-ethyl-1,3-propanediol (BEPD), 2-methyl-1,3-propanediol (MPO), neopentyl glycol (NPG), 2-methyl-2,4-pentanediol (MPD), 2-octyldodecane-1,2-diol, branched alkyl comb diol (BACD), other suitable branched diol or a combination thereof. The depolymerizing agent can destroy the crystallinity, so that the block structure of the polyester-polyether polyol is formed into an amorphous and non-crystalline structure, and the elongation rate thereof is increased. For example, the branched diol and the polyether chain segment are originally used to destroy the crystallinity of PET. However, in embodiments of the disclosure, the polyester (such as PTA) chain segment of the PU structure will reorient to create strain-induced crystallization when strains is applied to the PU film, and thus the strain hardening phenomenon occurs. Accordingly, the elongation rate is increased.

The polyether polyol is not particularly limited, and an appropriate polyether polyol can be selected according to requirements. The polyether polyol may include a polyether diol or other suitable polyether polyol. The polyether diol may include poly (ethylene glycol), poly (propylene glycol), poly (butylene glycol), poly (tetramethylene ether) glycol, diethylene glycol (DEG), triethylene glycol (TEG), other suitable polyether glycols, or a combination thereof. The weight average molecular weight of the polyether diol is 1000 to 5000 g/mole. The polyether polyol can be used alone or in combination. In one embodiment, the polyether polyol is preferably polyethylene glycol. The polyether polyol can provide the formed polyester-polyether polyol with a good hydrophilic moisture permeability, so as to improve a water vapor diffusion rate.

The catalyst is not particularly limited, and an appropriate catalyst can be selected according to requirements. For example, the catalyst may include sodium methoxide, sodium hydroxide, potassium hydroxide, titanium butoxide, titanium (IV) isopropoxide, zinc acetate or other suitable catalysts.

The diisocyanate is not particularly limited, and an appropriate diisocyanate can be selected according to requirements. A weight ratio of the diisocyanate to the polyester-polyether polyol is 10:70 to 20:60.

For example, the diisocyanate may include an aromatic diisocyanate, an aliphatic diisocyanate, or a combination thereof. The aromatic diisocyanate includes toluene diisocyanate (TDI), 4,4-diphenylmethane diisocyanate (4,4-MDI), 2,4′-diphenylmethane diisocyanate or a combination thereof. The aliphatic diisocyanate includes hexamethylene diisocyanate, cyclohexane diisocyanate, dicyclohexylmethane diisocyanate (DMDI), isophorone diisocyanate (IPDI) or a combination thereof. The diisocyanate can be used alone or in combination. In one embodiment, the diisocyanate is preferably 4,4-diphenylmethane diisocyanate.

The chain extender is not particularly limited, and an appropriate chain extender can be selected according to requirements. In one embodiment, the chain extender may include ethylene glycol, 1,3-propylene glycol, 1,4-butanediol, neopentyl glycol, 1,5-pentanediol, 1,6-hexanediol, 1,1,1-trimethylolpropane or other suitable chain extender. The chain extender may be used alone or in combination.

The solvent is not particularly limited, and an appropriate solvent can be selected according to requirements. For example, the solvent may include dimethylformamide (DMF), methyl ethyl ketone (MEK), toluene (TOL) or other suitable solvents. The solvent can be used alone or in combination. In one embodiment, the solvent is preferably a mixed solvent of dimethylformamide and toluene (DMF/TOL).

The additive is a defoamer, a wetting and leveling agent, an anti-blocking agent, a crosslinking agent, etc., and the additive can be used alone or in combination. An appropriate additive can be selected according to the requirements for the coating process of the polyurethane resin.

In embodiments, recycled polyester is used to replace traditional petroleum-based raw material sources, and thus the benefits of product carbon reduction can be achieved and the circular economy can be promoted.

In embodiments of the disclosure, the preparation method of the polyurethane includes the following steps. First, under the use of a catalyst, a chemical polymerization of a polyester and a polyether polyol is carried out to form a polyester-polyether polyol. Next, the polyester-polyether polyol and a diisocyanate are subjected to an addition reaction to form a polyurethane. In embodiments, the polyester-polyether polyol is obtained by chemical polymerization of a polyester monomer, a polyether diol and a catalyst. In one embodiment, the polyester monomer can be a phthalic acid oligomer, an analog thereof or a combination thereof, wherein the phthalic acid oligomer is, for example, dimethyl terephthalate, dimethyl isophthalate, dimethyl phthalate, the like or a combination thereof.

In embodiments, the preparation method of the polyurethane may include the following steps. First, a polyester monomer, a polyether polyol and a catalyst are polymerized at a temperature of 230° C. to 250° C. for 2 hours to 3 hours, then the temperature is lowered to 180° C. to 220° C., the pressure is gradually reduced, and the diol is removed, so as to increase the molecular weight of the product. Next, the temperature is reduced to 100° C.˜140° C. and the pressure is returned to normal pressure, to obtain a polyester-polyether polyol. Then, a diisocyanate is added to react with the polyester-polyether polyol at a temperature of 70° C. to 90° C. for 4 hours to 6 hours, and more diisocyanate is added repeatedly until the viscosity value of the obtained polymer reaches the set range, to obtain a polyurethane of an embodiment of the disclosure.

The polyether diol and the catalyst are as mentioned above, and will not be described in detail here.

An exemplary embodiment of the disclosure provides a fabric prepared using the above-mentioned polyurethane.

A tough, elastic and moisture-permeable fabric can be formed by coating the above-mentioned polyurethane on a fabric to form a coating film, and drying (shaping) the coating film. For example, after the polyurethane is coated on a fabric, the temperature is raised in stages at 120-160° C. and dried for 60-120 seconds to form a coating film on the fabric, thereby improving the moisture absorption and sweat-wicking properties of the fabric.

The fabric may be made of synthetic fibers, natural fibers, semi-synthetic fibers or other suitable fibers, including non-woven fabrics; there is not particularly limited thereto.

The coating method is not particularly limited, but a dip-pump method, a jet coating method, or other suitable methods may be used, and in general, a dip-pump method is widely used.

Hereinafter, the disclosure will be described in detail with reference to examples. The following examples are provided to describe the disclosure, and the scope of the disclosure includes the scope described in the following claims and their substitutions and modifications, and are not limited to the scope of the examples.

The preparation procedure of the polyurethane described in the disclosure will be described below with preparation examples and embodiments, and the elasticity and moisture permeable properties of the polyurethane of the embodiments will be measured.

A 5000 ml reactor was provided and equipped with a stirrer, a fractionation column (vigreux), a short path condenser head with a distillation collecting flask, a cylindrical heater, and a thermoelectrically coupled nitrogen inlet.

### Preparation of Polyester-Polyether Polyol

### Measurement of Alcohol Value

According to ASTM E 1899-08 standard measurement method, the alcohol value is measured.

### Measurement of Acid Value

According to ASTM E 1899-08 standard measurement method, the acid value is measured.

### Preparation Example 1

About 384 g of recycled PET bottle flakes, about 142 g of BEPD (2-Butyl-2-ethyl-1,3-propanediol, TCI ≥98.0%, Showa Chemical Industry Co., Ltd.), about 418 g of PEG-600 (PEG-600,Showa Chemical Industry Co., Ltd.) and about 0.095 g (about 0.1 wt % of the feed) of 99% zinc acetate (Zinc acetate, Sigma-Aldrich) were charged into a reactor. Next, the above mixture was stirred and heated to 240° C. under a nitrogen atmosphere at normal pressure for 1 to 2 hours, to generate a depolymerization product. Then, the temperature of the reaction solution was lowered to 220° C. and a vacuum pump was connected to gradually reduce the pressure, so that the molecular weight of the depolymerized product was increased until the removed amount of the ethylene glycol reached the set volume. Then, the temperature of the reaction solution was lowered to 100° C. and returned to normal pressure, to obtain a polyester-polyether polyol (I). Test results show that the polyester-polyether polyol (I) has an alcohol value of 47.5 mgKOH/g, an acid value of 0.25 mgKOH/g, and is a low viscosity liquid at room temperature. The alcohol value and the acid value will be used to calculate the weight average molecular weight of the polyester-polyether polyol.

### Preparation Example 2

About 384 g of recycled PET bottle flakes, about 372.5 g of DEG, about 472 g of PEG-1000 (PEG-1000, Alfa Aesar) and about 0.095 g (about 0.1wt % of the feed) of 99% zinc acetate were charged into a reactor. Next, the above mixture was stirred and heated to 240° C. for 1-2 hours, to generate a depolymerization product. Then, the temperature of the reaction solution was lowered to 220° C. and a vacuum pump was connected to gradually reduce the pressure, so that the molecular weight of the depolymerized product was increased until the removed amount of the ethylene glycol reached the set volume. Then, the temperature of the reaction solution was lowered to 100° C. and the pressure was returned to normal pressure, to obtain a polyester-polyether polyol (II). Test results show that the polyester-polyether polyol (II) has an alcohol value of 34.4 mgKOH/g, an acid value of 0.24 mgKOH/g, and is a low viscosity liquid at room temperature.

### Preparation Example 3

About 384 g of recycled PET/PU composite fabric, about 119 g of PEG-400 (PEG-400, Showa Chemical Industry Co., Ltd.), about 418.5 g of PEG-1000, about 422 g of DEG (Diethylene glycol, Jingming Chemical Industry) and about 0.095 g (about 0.1 wt % of the feed) of 99% zinc acetate (Sigma-Aldrich 99.99%) were charged into a reactor. Next, the above mixture was stirred and heated to 240° C. for 1-2 hours, to generate a depolymerization product. Then, the temperature of the reaction solution was lowered to 220° C. and a vacuum pump was connected to gradually reduce the pressure, so that the molecular weight of the depolymerized product was increased until the removed amount of the ethylene glycol removed reached the set volume. Then, the temperature of the reaction solution was lowered to 100° C. and the pressure was returned to normal pressure, to obtain a polyester-polyether polyol (III). Test results show that the polyester-polyether polyol (III) has an alcohol value of 30.0 mgKOH/g, the acid value of 0.33 mgKOH/g, and is a viscous liquid at room temperature.

### Preparation Example 4

About 204 g of DMT monomer (DMT/technical grade, ACROS), about 60 g of PEG-400, about 210 g of PEG-1000, about 265 g of DEG and about 0.074 g (about 0.1wt % of the feed) of zinc acetate were charged into a reactor. Next, the above mixture was stirred and heated to 240° C. to undergo an esterification reaction for 2 to 3 hours, and then the reaction solution was cooled to 200° C. and connected to a vacuum pump to gradually reduce the pressure, so that the molecular weight of the product was increase until the removed amount of ethylene glycol reached the set volume. Then, the reaction solution was cooled to 120° C. and the pressure was returned to normal pressure, to obtain a polyester-polyether polyol (IV). Test results show that the polyester-polyether polyol (IV) has an alcohol value of 24.2 mgKOH/g, an acid value of 0.1 mgKOH/g, and is a viscous liquid at room temperature.

### Synthesis of Polyurethane

### Measurement of Elongation Rate

According to ASTM D-412 C, the test piece was cut into a dumbbell-shaped specimen with a cutter, and the tensile machine (HT-2012AP, Hongda Instruments) was used, with the chuck separation speed set at 500 mm/min for testing.

### Measurement of Moisture Permeability

According to JIS L1099 A1, the test piece was fixed on the moisture-permeable cup and the moisture-permeable cup was placed in a constant temperature and humidity testing machine (GTH-225-40-1P-U, Jufu Instrument). The ambient temperature was set at 40° C. and the ambient humidity was set at 90% RH, to measure the moisture permeability of the test piece.

### Example 1

About 66.7 g of the polyester-polyether polyol prepared in Preparation Example 1, about 5.6 g of 1,4-butanediol and about 226 g of a mixed solvent DMF/TOL were added into a 0.5-liter four-port glass reaction tank. Then, about 19.7 g of 4,4-MDI was added to the above mixture, and the temperature was raised to 80° C. to carry out the reaction. The viscosity of the mixture slowed down as the reaction progressed, and then about 0.24 g of 4,4-MDI was added. The previous steps were repeated until the viscosity value reached the target set range (20˜30% solid content and 1000˜100,000 cP/25° C.), to obtain a polyurethane resin (I). The polyurethane resin (I) was analyzed by nuclear magnetic resonance spectrum, and the spectrum information obtained was shown in FIG. 1. The elongation rate and the moisture permeability test results are: the elongation rate is 627%, and the moisture permeability is 5086 g/m²·24 hours.

### Example 2

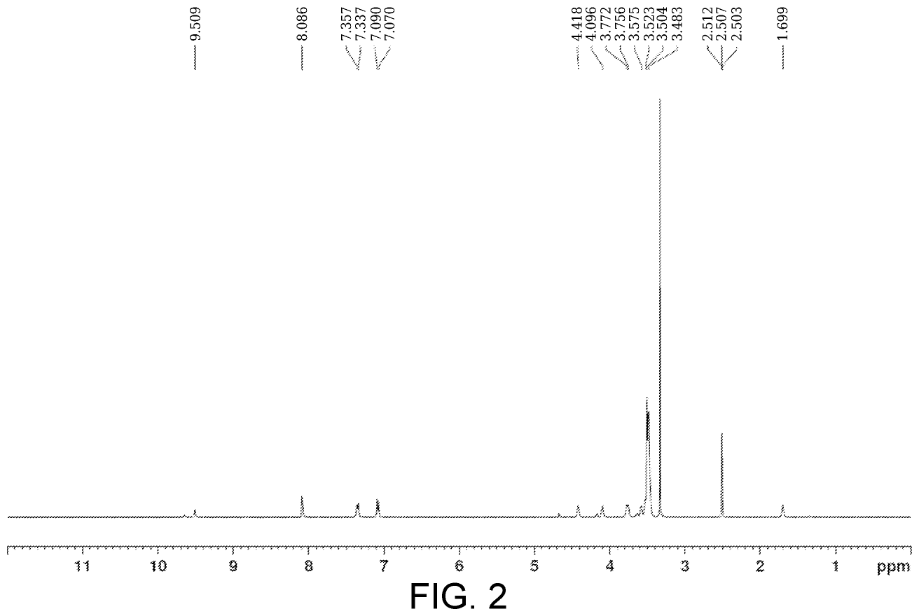

About 74.5 g of the polyester-polyether polyol prepared in Preparation Example 1, about 18.2 g of PEG-2000 (PEG-2000 reagent grade, Showa Chemical Industry Co., Ltd.), about 8.2 g of 1,4-butanediol and about 318.8 g of a mixed solvent DMF/TOL were added into a 0.5-liter four-port glass reaction tank. Then, about 28.6 g of 4,4-MDI was added to the above mixture, and the temperature was raised to 80° C. to carry out the reaction. The viscosity of the mixture slowed down as the reaction progressed, and then about 0.35 g of 4,4-MDI was added. The previous steps were repeated until the viscosity value reached the target set range, to obtain a polyurethane resin (II). The polyurethane resin (II) was analyzed by nuclear magnetic resonance spectrum, and the spectrum information obtained was shown in FIG. 2. The elongation rate and the moisture permeability test results are: the elongation rate is 843%, and the moisture permeability is 5090 g/m²·24 hours.

### Example 3

About 363.4 g of the polyester-polyether polyol prepared in Preparation Example 2, about 62.9 g of PEG-2000, about 32.1 g of 1,4-butanediol and about 1375.9 g of a mixed solvent DMF/TOL were added in a 0.5-liter four-port glass reaction tank. Then, about 105 g of 4,4-MDI was added to the above mixture, and the temperature was raised to 80° C. to carry out the reaction.

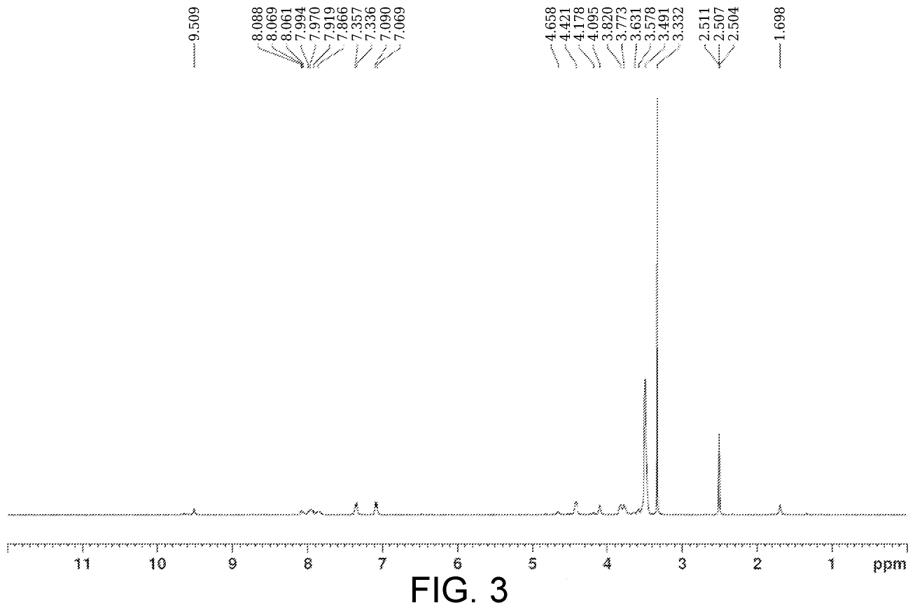

The viscosity of the mixture slowed down as the reaction progressed, and then about 1.3 g of 4,4-MDI was added. The previous steps were repeated until the viscosity value reached the target set range, to obtain a polyurethane resin (III). The polyurethane resin (III) was analyzed by nuclear magnetic resonance spectrum, and the spectrum information obtained was shown in FIG. 3. The elongation rate and the moisture permeability test results are: the elongation rate is 1032%, and the moisture permeability is 5366 g/m²·24 hours.

### Example 4

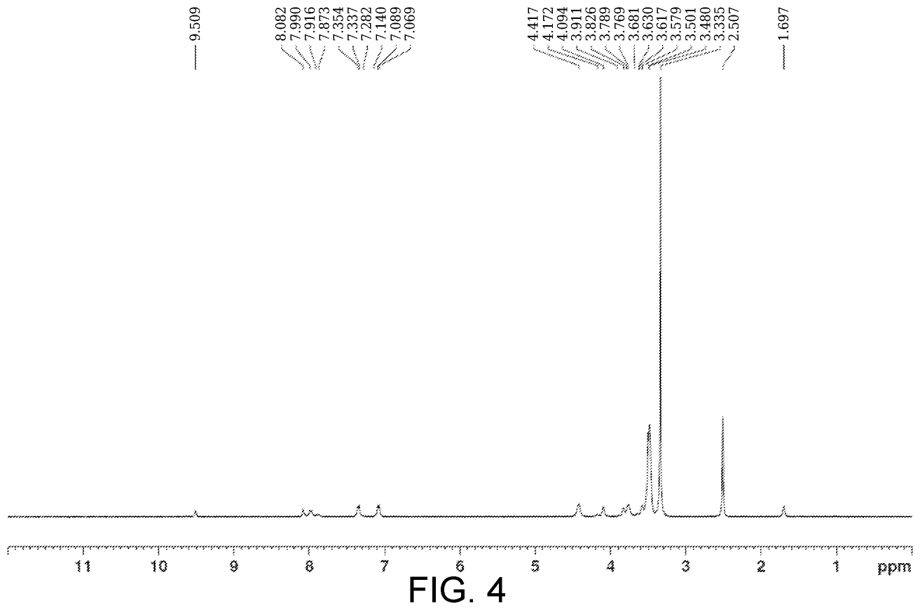

About 85.5 g of the polyester-polyether polyol prepared in Preparation Example 3, about 12.9 g of PEG-2000, about 7.9 g of 1,4-butanediol and about 321 g of a mixed solvent DMF/TOL were added in a 0.5-liter four-port glass reaction tank. Then, about 24.7 g of 4,4-MDI was added to the above mixture, and the temperature was raised to 80° C. to carry out the reaction. The viscosity of the mixture slowed down as the reaction progressed, and then about 0.3 g of 4,4-MDI was added. The previous steps were repeated until the viscosity value reached the target set range, to obtain a polyurethane resin (IV). The polyurethane resin (IV) was analyzed by nuclear magnetic resonance spectrum, and the spectrum information obtained was shown in FIG. 4. The elongation rate and the moisture permeability test results are: the elongation rate is 884%, and the moisture permeability is 4502 g/m²·2.24 hours.

### Example 5

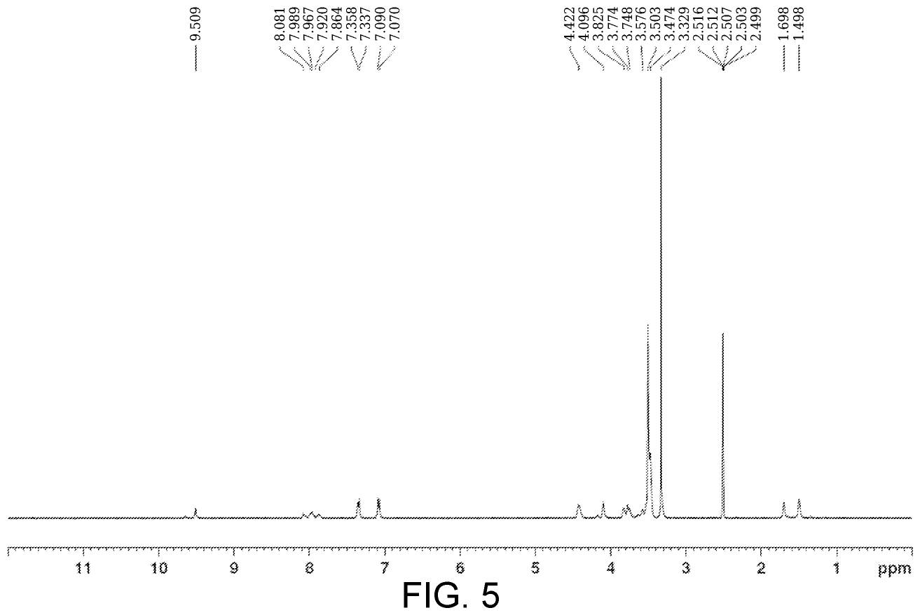

About 54.6 g of the polyester-polyether polyol prepared in Preparation Example 4, about 23.5 g of PEG-2000, about 7.9 g of 1,4-butanediol and about 302 g of a mixed solvent DMF/TOL were added in a 0.5-liter four-port glass reaction tank. Then, about 25.3 g of 4,4-MDI was added to the above mixture, and the temperature was raised to 80° C. to carry out the reaction. The viscosity of the mixture slowed down as the reaction progressed, and then about 0.6 g of 4,4-MDI was added. The previous steps were repeated until the viscosity value reached the target set range, to obtain a polyurethane resin (V). The polyurethane resin (V) was analyzed by nuclear magnetic resonance spectrum, and the spectrum information obtained was shown in FIG. 5. The elongation rate and the moisture permeability test results are: the elongation rate is 894%, and the moisture permeability is 5116 g/m²·24 hours.

### Comparative Example 1

The polyurethane resin was purchased from Delta Synthetic Co., Ltd., (trade name: CW-2230). The elongation rate and the moisture permeability test results are: the elongation rate is 435%, and the moisture permeability is 6300 g/m²·24 hours.

### Comparative Example 2

About 48 g of polytetramethylene ether glycol-2000 (PTMEG-2000 technical grade, Dalian Chemical Industry Co., Ltd.), about 32 g of PEG-2000, about 10.8 g of 1,4-butanediol and about 309.8 g of a mixed solvent DMF/TOL were added the into a 0.5-liter four-port glass reaction tank. Then, about 33.6 g of 4,4-MDI was added to the above mixture, and the temperature was raised to 80° C. to carry out the reaction. The viscosity of the mixture slowed down as the reaction progressed, and then about 0.42 g of 4,4-MDI was added. The previous steps were repeated until the viscosity value reached the target set range, to obtain a polyurethane resin. The elongation rate and the moisture permeability test results are: the elongation rate is 411%, and the moisture permeability is 4450 g/m²·24 hours.

### Comparative Example 3

About 40.6 g of the polyester-polyether polyol prepared in Preparation Example 1, about 38.8 g of PEG-2000, about 10.4 g of 1,4-butanediol and about 303.3 g of a mixed solvent DMF/TOL were added into a 0.5-liter four-port glass reaction tank. Then, about 32.3 g of 4,4-MDI was added to the above mixture, and the temperature was raised to 80° C. to carry out the reaction. The viscosity of the mixture slowed down as the reaction progressed, and then about 0.4 g of 4,4-MDI was added. The previous steps were repeated until the viscosity value reached the target set range, to obtain a polyurethane resin. The elongation rate and the moisture permeability test results are: the elongation rate is 330%, and the moisture permeability is 4116 g/m²·24 hours.

TABLE 1

| | Polyester product | | | | | | |
|---|---|---|---|---|---|---|---|
| | (parts by weight) | | | | Polyether diol | | |
| | PET | PET/PU | Polyester monomer | Branched diol | (parts by weight) | | |
| | bottle | composite | (parts by weight) | (parts by weight) | PEG | PEG | |
| | flakes | fabric | DMT | BEPD | 200~400 | 600~1000 | DEG |
| Preparation | 1 | 0 | 0 | 0.37 | 0 | 1.09 | 0 |
| Example 1 | | | | | | | |
| Preparation | 1 | 0 | 0 | 0 | 0 | 1.23 | 0.97 |
| Example 2 | | | | | | | |
| Preparation | 0 | 1 | 0 | 0 | 0.31 | 1.09 | 1.10 |
| Example 3 | | | | | | | |
| Preparation | 0 | 0 | 1 | 0 | 0.29 | 1.02 | 1.3 |
| Example 4 | | | | | | | |

TABLE 2

| | | | | | Product |
|---|---|---|---|---|---|
| | | | Alcohol value | Acid value | appearance at |
| | PET(wt %) | PEG(wt %) | (mg KOH/g) | (mg KOH/g) | room temperature |
| Preparation | 34.2 | 56.5 | 47.5 | 0.25 | Low viscosity |
| Example 1 | | | | | liquid |
| Preparation | 32.4 | 53.8 | 34.4 | 0.24 | Low viscosity |
| Example 2 | | | | | liquid |
| Preparation | 30.7 | 61.6 | 30.0 | 0.33 | Viscous dark- |
| Example 3 | | | | | colored liquid |
| Preparation | 31 | 59.6 | 24.2 | 0.10 | Viscous liquid |
| Example 4 | | | | | |

TABLE 3

| | | | Elongation | Moisture |
|---|---|---|---|---|
| | PET in PU | PEG in PU | rate | permeability |
| | (wt %) | (wt %) | (%) | (g/m² · 24 hours) |
| Example 1 | 15.8 | 52.9 | 627 | 5086 |
| Example 2 | 20.2 | 42.2 | 843 | 5090 |
| Example 3 | 20.0 | 48.8 | 1032 | 5366 |
| Example 4 | 20.0 | 48.1 | 884 | 4502 |
| Example 5 | 13.1 | 44.3 | 894 | 5116 |
| Comparative | 0 | N/A | 435 | 6300 |
| Example 1 | | | | |
| Comparative | 0 | 24 | 411 | 4450 |
| Example 2 | | | | |
| Comparative | 7.2 | 24 | 330 | 4116 |
| Example 3 | | | | |

As shown in Table 3, it can be seen from the test results of Examples 1-5 that the elongation rate of the polyurethane is equal to or greater than 500%, and the moisture permeability is equal to or greater than 4000 g/m²·24 hours. From the test results of Comparative Examples 1-3, Example 1 and Example 2, it can be seen that compared with the commercially available waterproof and moisture-permeable product (comparative example 1), the sample without the chemical structure of Formula 4 (comparative example 2) and the sample containing the chemical structure of Formula 4 but the proportion of the aryl group in PET in Formula 3 (i.e., R5) is less than 10% (comparative example 3), the elongation rates of Examples 1 and 2 of the disclosure are 10 better. Furthermore, from the test results of Comparative Example 3, Example 1, and Example 2, it can be known that the elongation rate increases significantly as the proportion of PET increases. From the test results of Example 2 and Example 3, it can be seen that since polyether diol (DEG) itself is hydrophilic, it can improve the moisture permeability of the synthesized polyurethane, and the polyether structure can further improve the elongation rate of polyurethane. On the other hand, it can be seen from Example 4 that high moisture permeability can still be achieved by using PET/PU composite fabric as raw material. It can be seen from Example 5 that a high elongation rate and high moisture permeability can still be achieved by using a chemical synthesis method to adopt a polyester-polyether polyol as raw material.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A polyurethane, comprising a chemical structure represented by Formula 1, 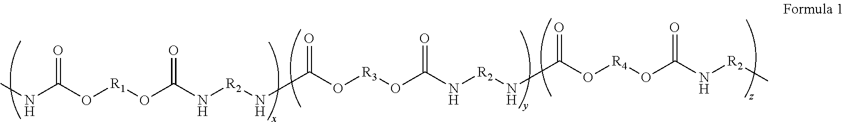
wherein R₁ is represented by Formula 2, 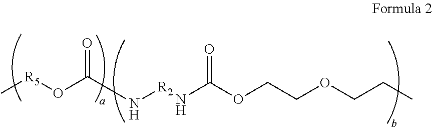
R₂ is independently a substituted or unsubstituted aryl group or alkyl group with a carbon number of 2 to 15;
R₃ is a substituted or unsubstituted alkyl group with a carbon number of 2 to 10;
R₄ is independently a substituted or unsubstituted alkyl group, oxyalkyl group or polydiacid glycol group with a carbon number of 20 to 300; and
R₅ is represented by Formula 3, 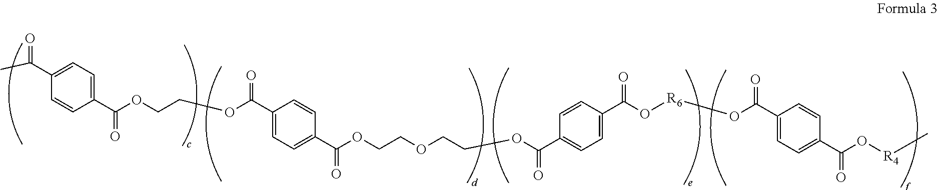
R₄ is the same as the aforementioned R₄;
R₆ is a substituted or unsubstituted branched alkyl group or ether group with a carbon number of 2 to 60, and
a and x are each independently an integer from 1 to 100, b, c, d, e and f are each independently
an integer from 0 to 100, y is an integer from 0 to 50, and z is an integer from 0 to 50.

2. The polyurethane as claimed in claim 1, wherein R₂ is diphenylmethyl group, tolyl group, dicyclohexyl methyl group, hexamethylene group, cyclohexyl group or 1,1,3-trimethylcyclohexyl group.

3. The polyurethane as claimed in claim 1, wherein R₃ is ethyl group, n-propyl group, n-butyl group, n-pentyl group, neopentyl group, hexyl group, dimethylpropyl group or ethoxy ethylpropyl group.

4. The polyurethane as claimed in claim 1, wherein R₄ is ethoxy (EO) group, isopropoxy (PO) group, butoxy (BO) group, polyethoxypropoxy group, polyethoxybutoxyphenol group, phenolic methyl group, caprolactone group, ethylene adipate group, butylene adipate group or hexamethylene adipate group.

5. The polyurethane as claimed in claim 1, wherein R₆ is 2-methyl-2,4-pentyl group, 2-butyl-2-ethyl propyl group, diethyl ether group or dimethyl propylene group.

6. A preparation method of a polyurethane, comprising:
subjecting a polyester-polyether polyol and a diisocyanate to an addition reaction, and obtaining a polyurethane,
wherein the polyester-polyether polyol has a chemical structure represented by Formula 4, 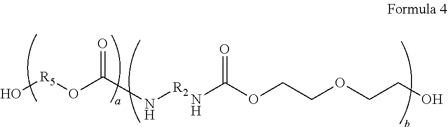
wherein R₂ is a substituted or unsubstituted aryl group or alkyl group with a carbon number of 2 to 15; and
R₅ is represented by Formula 3, 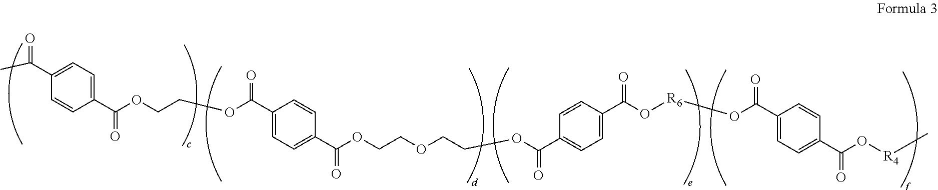
wherein R₄ is a substituted or unsubstituted alkyl group, oxyalkyl group or polydiacid glycol group with a carbon number of 20 to 300;
R₆ is a substituted or unsubstituted branched alkyl group or ether group with a carbon number of 2 to 60; and
wherein a is an integer from 1 to 100, and b, c, d, e and f are each independently an integer from 0 to 100.

7. The preparation method of a polyurethane as claimed in claim 6, wherein the polyester-polyether polyol, based on a total weight of the polyester-polyether polyol, comprises a polyester segment of 25 wt % to 40 wt %, and a polyether segment of 50 wt % to 70 wt %.

8. The preparation method of a polyurethane as claimed in claim 6, wherein the polyester-polyether polyol is obtained by polymerizing phthalic acid oligomers, polyether diols and a catalyst.

9. The preparation method of a polyurethane as claimed in claim 8, wherein the polyether diol comprises poly (ethylene glycol), poly (propylene glycol), poly (butylene glycol), poly (tetramethylene ether) glycol or a combination thereof, and a weight average molecular weight of the polyether diol is 1000 to 5000 g/mole.

10. The preparation method of a polyurethane as claimed in claim 6, wherein the diisocyanate comprises an aromatic diisocyanate, an aliphatic diisocyanate or a combination thereof.

11. The preparation method of a polyurethane as claimed in claim 10, wherein the aromatic diisocyanate comprises toluene diisocyanate, 4,4-diphenylmethane diisocyanate, 2,4′-diphenylmethane diisocyanate or a combination thereof, and the aliphatic diisocyanate includes hexamethylene diisocyanate, cyclohexane diisocyanate, dicyclohexylmethane diisocyanate, isophorone diisocyanate or a combination thereof.

12. The preparation method of a polyurethane as claimed in claim 7, wherein the polyester segment of the polyester-polyether polyol is obtained by chemically depolymerizing waste polyester, and the waste polyester is PET pellets, PBT pellets, recycled polyester bottle flakes, recycled polyester films, recycled polyester fibers, recycled PET fabrics, recycled PET/PU composite fabrics, or a combination thereof.

13. The preparation method of a polyurethane as claimed in claim 12, wherein a depolymerizing agent is added while chemically depolymerizing the waste polyester.

14. The preparation method of a polyurethane as claimed in claim 13, wherein the depolymerizing agent comprises diethylene glycol (DEG), 2-butyl-2-ethyl-1,3-propanediol (BEPD), 2-methyl-1,3-propanediol (MPO), neopentyl glycol (NPG), 2-methyl-2,4-pentanediol (MPD), 2-octyldodecane-1,2-diol, branched alkyl comb diol (BACD) or a combination thereof.

15. The preparation method of a polyurethane as claimed in claim 6, further comprising adding a chain extender.

16. The preparation method of a polyurethane as claimed in claim 6, wherein a weight ratio of the diisocyanate to the polyester-polyether polyol is 10:70 to 20:60.

17. The preparation method of a polyurethane as claimed in claim 15, wherein the chain extender comprises ethylene glycol, 1,3-propylene glycol, 1,4-butanediol, neopentyl glycol, 1,5-pentanediol, 1,6-hexanediol, 1,1,1-trimethylolpropane or a combination thereof.
